(19) United States
(12) Patent Application Publication
(10) Pub. No.: US 2026/0360334 A1
(43) Pub. Date: Nov. 12, 2026

(54) FAST AND LIGHTWEIGHT WRITING OF PIXELS IN AN ACTIVE MATRIX DIGITAL DISPLAY BASED ON AN ADAPTATION OF THE PIXEL BIT DEPTH IN A COMMAND

(71) Applicant: MICROOLED, GRENOBLE (FR)

(72) Inventors: Laurent CHARRIER, GRENOBLE (FR); Matthieu WINDIC, GRENOBLE (FR); Thomas CUBIZOLLE, GRENOBLE (FR)

(73) Assignee: MICROOLED, GRENOBLE (FR)

(21) Appl. No.: 19/132,982

(22) PCT Filed: Dec. 19, 2023
(86) PCT No.: PCT/EP2023/086582

§ 371 Date: May 27, 2025

(30) Foreign Application Priority Data
Dec. 23, 2022 (EP) 22307034.3

(51) Int. Cl. G09G 5/395; G09G 3/20; G09G 3/3225

(52) U.S. Cl. CPC G09G 5/395; G09G 3/2096; G09G 3/3225; G09G 2340/02; G09G 2340/0428; G09G 2370/04

(57) ABSTRACT

The invention relates to an active matrix digital display comprising: a plurality of pixels, each pixel comprising a memory storing one or more values of intensity of the pixel; an interface configured, upon the reception of at least one command to write pixel intensities in a region of the screen, to: determine, from at least one of an identifier of a type of the command, and parameters of the command, a bit depth of the pixel intensity representation in the payload of the command; write to the memory from the payload of the command values of intensities of pixels of the region of the screen according to said bit depth of the pixel intensity representation in the payload and a pixel path associated to said region of the screen; wherein said write comprises a conversion between the bit depth of the pixel intensity representation in the payload, and the bit depth of the pixel intensity representation in the memory, if the bit depth of the pixel intensity representation in the payload and the bit depth of the pixel intensity representation in the memory are different.

### TECHNICAL FIELD

This disclosure pertains to the field of active matrix digital displays; More specifically, it pertains to the field of pixel writing in active matrix digital displays.

### BACKGROUND ART

Active matrix digital displays are displays wherein each pixel is associated with an address and comprises a memory storing one or more pixel intensities, and each pixel can be written independently. An active matrix display may be for example a LCD, AMOLED or AMLED display or microdisplay.

The memory of a pixel may store a single value of intensity if the pixel is a grayscale pixel, or a plurality of values of intensities of a plurality of color layers if the pixel is a color pixel such as a RGB pixel for example. Each pixel may further comprise a DAC (Digital to Analog Converter) that converts the values of intensities stored in the memory of the pixel into a voltage or current of one or more electroluminescent element of the pixel.

The memories of the pixel may be static memories, such as SRAM (Static Random Access Memories), or volatile memories. Volatile memories need to be refreshed, while the values stored in static memories remains stored without time limitation, until being erased and replaced by a new values. Pixels comprising static memories are for example described by Hao, D., Aiying, G., & Feng, R. (2020, November). A New Low-power Pixel Circuit for OLEDoS Microdisplay. In 2020 17th China International Forum on Solid State Lighting & 2020 International Forum on Wide Bandgap Semiconductors China (SSLChina: IFWS) (pp. 211-214). IEEE., and Vogel, U., Beyer, B., Schober, M., Wartenberg, P., Brenner, S., Bunk, G., . . . & Richter, B. (2017, May). 77-1: Invited Paper: Ultra-low Power OLED Microdisplay for Extended Battery Life in NTE Displays. In SID Symposium Digest of Technical Papers (Vol. 48, No. 1, pp. 1125-1128).

Active matrix digital displays are usually provided with an interface which is responsible for receiving commands and writing pixels intensities in memory accordingly. The interface may be a serial interface, or a parallel interface. Examples of serial interfaces comprise for example I2C, SPI or CAN interfaces, although virtually any kind of serial interface can be used in active matrix digital displays.

When an active matrix display needs to be written, a command is usually sent which comprises a bitmap image of all the pixels of the display to be written. Thus, all the values of intensities of all the pixels of the image are transferred through the interface. This causes a significant delay in writing the values and consumes a significant amount of energy.

There is therefore the need for a reduction of the amount of data to be transferred for writing an active matrix display screen.

### SUMMARY

This disclosure improves the situation.

It is proposed an active matrix digital display comprising: a plurality of pixels, each pixel comprising a static memory adapted to store a plurality of n bits representing the intensity of the pixel; an interface configured, upon the reception of at least one command to write pixel intensities in a region of the screen, to: determine, from at least one of an identifier of a type of the command, and parameters of the command, a bit depth of the pixel intensity representation in the payload of the command; write to the memory from the payload of the command values of intensities of pixels of the region of the screen according to said bit depth of the pixel intensity representation in the payload and a pixel path associated to said region of the screen; wherein said write comprises a conversion between the bit depth of the pixel intensity representation in the payload, and the bit depth of the pixel intensity representation in the memory, if the bit depth of the pixel intensity representation in the payload and the bit depth of the pixel intensity representation in the memory are different and wherein the pixel intensity representations in the payload are concatenated for each successive pixel in the region according to the pixel path.

By “interface”, we designate an interface that is able to receive commands and analyze commands to write in the static memory accordingly. The interface may comprise wires and an electronic circuit. The interface may for example be a serial or a parallel input interface. A serial interface may for example by a SPI interface. The interface may be an input interface, or a input and an output interface.

By “region of the screen”, we designate a contiguous part of the screen which may be either the whole screen or a subpart of the screen. Such a subpart of the screen may be for example a row, a column, or a 2D shape such as a rectangle, a circle or a predefined shape

By “an identifier of the type of the command”, we designate a fraction of the command, for example a bit pattern, which designate which to which type the command belongs to.

By “one or more values intensity”, we designate at least one intensity that defines the layout of the pixel.

The layout of a pixel may be defined by a single value of intensity, for example if the pixels are grayscale pixels, or a plurality of values of intensities, for example if the pixels are defined by a plurality of color channels. For example, a RGB pixel comprises 3 sub-pixels, each of the 3 sub-pixels being associated to one value of intensity. Other color representations are also usable, such as RG (2 color channels for Red and Green, for two sub-pixels for each pixel) or RGBW (4 color channels for Red, Green, Blue and White, for two sub-pixels for each pixel) representation for example.

By “pixel path”, we designate a series of absolute or relative position of pixels for going through the whole 2D shape. For example:
if the 2D shape is a rectangle, the pixel path may consist in writing the lines of the rectangle from top to bottom and from left to right;
if the 2D shape is a mouse arrow, the pixel path may consist in writing the pixels of the arrow from top to bottom and from left to right, with a different number of pixels at each line;
Etc.

The pixel path may be associated to the command type, or defined by one or more parameters of the command. For example, if the commands aim at writing a rectangle, at least one parameter may define if the rectangle is to be written from top to bottom or from bottom to top.

By “conversion”, we designate defining, from a value of intensity of pixel using a first bit depth, an equivalent value in a second bit depth.

This allows exchanging through the interface bit data to write using different bit depths depending upon the commands and/or parameters. Therefore, the intensities of pixel can be written using the smaller bit depth that is actually needed for each command. Therefore, this provides a faster pixels writing, and saves energy compared to a complete writing of the pixels of the screen.

In another aspect, it is proposed a display device comprising: the digital display according to an embodiment of the invention; a processing unit configured to send to the interface of said digital display at least one command.

We designate by “processing unit” an electronic component capable of performing electronic or computer calculations for a function. A processing unit can designate any type of processor or electronic component capable of performing digital calculations. For example, a processing unit can be an integrated circuit, an ASIC (from the English acronym “Application-Specific Integrated Circuit”, literally in French “integrated circuit specific to an application”, a microcontroller, a microprocessor, a Digital Signal Processor (DSP), a processor, a Graphical Processing Unit (GPU). A processing unit according to the invention is not limited to a particular type of calculation architecture. For example, a processor can implement a Harvard or Von Neumann type architecture.

In another aspect, it is proposed a display device comprising: the digital display according to an embodiment of the invention; a processing unit configured to send to the interface of said digital display at least one command.

In another aspect, it is proposed a method executed by an active matrix digital display comprising: a plurality of pixels, each pixel comprising a static memory adapted to store a plurality of n bits representing the intensity of the pixel; an interface; said method comprising: receiving, by the interface, at least one command to write pixel intensities in a region of the screen; determining, from at least one of an identifier of a type of the command, and parameters of the command, a bit depth of the pixel intensity representation in the payload of the command; writing to the memory from the payload of the command, values of intensities of pixels of the region of the screen according to said at least one parameter and a pixel path associated to said region of the screen; wherein said writing comprises a conversion between the bit depth of the pixel intensity representation in the payload, and the bit depth of the pixel intensity representation in the memory, if the bit depth of the pixel intensity representation in the payload and the bit depth of the pixel intensity representation in the memory are different and wherein the pixel intensity representations in the payload are concatenated for each successive pixel in the region according to the pixel path.

In another aspect, it is proposed a computer software or system firmware comprising instructions to implement at least a part of a method as defined here when the software or system firmware is executed by a processor.

In another aspect, it is proposed a computer-readable non-transient recording medium on which a software or system firmware is registered to implement the method as defined here when the software or system firmware is executed by a processor.

By “system firmware”, we designate a software that is directly embedded in a device, and participates to the functioning of the device.

The following features, can be optionally implemented, separately or in combination one with the others:

In a number of embodiments of the invention, at least one type of command is associated with a predefined bit depth.

This allows further reducing the size of the commands, because the bit depth does not need to be written in a parameter field different from the command type.

In a number of embodiments of the invention, the bit depth of the pixel intensity representation in the payload is equal to 1; said conversion comprises, for each pixel: if the pixel intensity representation of the pixel in the payload is a first possible binary value, write a maximum intensity of the pixel in the memory; if the pixel intensity representation of the pixel in the payload is a second possible binary value different from the first possible binary value, write a minimum intensity of the pixel in the memory.

By “possible binary value”, we designate the value 0 or 1.

This allows representing each pixel intensity using a single bit, representative of either a maximal or a minimum intensity. Therefore, the size of a write command can be drastically limited for writing very contrasted content

The pixel intensity representations in the payload are concatenated for each successive pixel in the region according to the pixel path.

By “concatenating pixel intensity representations according to the pixel path”, we designate putting the bits representing each pixel in an order of the bits which is defined by the pixel path.

This allows obtaining the most compact possible representation of the pixel intensities, because they are simply concatenated in a determined order.

In a number of embodiments of the invention, if the pixel intensity representation in the payload of the command is equal to the bit depth of the pixel intensity representation in the memory of the pixels divided to a power of 2 and, the conversion is performed by duplicating the bits from the payload to the memory to write to the memory from the payload of the command values of intensities of pixels.

This allows a conversion which is in the same time as exact as possible, and provides a low complexity, therefore further saving computational resources.

In a number of embodiments of the invention, if the type of the command of the command belongs to at least one type relative to a subset of the screen, said interface is further configured to read, in a predefined position of a payload of the command, at least one parameter relative to at least a pixel position in the screen.

By “at least one parameter relative to at least a pixel position in the display screen, we designate at least one parameter that allow retrieving a pixel position in the screen so that the position of the region in the display screen can be identified. The pixel position may be for example a position of a specific pixel of the region, such as for example the top left corner of a rectangle, or an extremity of an arrow. The invention is however not restricted to this example, and each pixel position allowing to precisely locating the zone in the screen can be used The pixel position may be for example expressed using a row and a column number. The at least one parameter may, in certain cases, comprise other parameters in addition of a pixel position. Such other parameters may for example comprise:
an indicative of a 2D shape (for example, is the 2D shape a square, a rectangle or a triangle, if this is not defined by the command type;
a size of the 2D shape;
an orientation of the 2D shape;
Etc.

This allows setting positions of regions representative of subset of the screen, and therefore reducing the size of the pixel representation when the write does not concern the whole screen.

In a number of embodiments of the invention, if the type of the command of the command belongs to at least one type relative to a 2D shape: said at least one parameter further comprises at least one parameter relative to at least one dimension of the 2D shape; the size of the payload of the command is dependent upon said at least one size; the pixel path is parameter according to said at least one dimension.

By “2D shape”, we designate a shape defined as a series of pixels in 2 dimensions. The 2D shape may be a generic shape (rectangle, triangle, square . . . ) associated with at least one parameter of dimension or a specific shape defined by a precise sequence of pixels, such as a mouse arrow for example.

By “at least one dimension of the 2D shape”, we designate at least one parameter which defines at least one dimension of the shape. Such at least one dimension may be for example:
a height and width of a rectangle;
a radius of a circle, the length of a side of a square;
a surface of a square;
a second pixel position which allows infering the dimensions of the shape;
etc.

In a number of embodiments of the invention, said type of the command defines a 2D shape associated to a predefined pixel path.

By “predefined pixel path”, we designate a path which is known in advance and fully defines the shape. For example, if the 2D shape is a mouse arrow, the pixels of the arrow can be numbered, and the payload of the command may contain in the order of increasing number of the pixels, so the pixels can be written in the relevant relative position only based on the command type, and a single pixel position.

This allows reducing the command sizes for specific 2D shapes, because the payload of the command does not need to contain parameters relative to a dimension of the shape to determine the pixel path. The reduction of the command size further reduces the energy consumption of the digital display.

This allows defining shapes of different sizes, such as rectangles, square or triangles of different sizes, and storing in the command only the data relative to a 2D shape of said size. Therefore, this allows sending and processing only the data that is useful according to the size of the shape. The combination of the pixel position and dimension of the shape allows defining shapes of various positions and sizes.

Said memory is a static memory.

By “static memory” we designate a memory where values are stored permanently until a further modification. A static memory may for example a SRAM (“Static Random Access Memory”). In a static memory digital display, the static memory stores intensities of pixels, and the display screen displays at any time the current value of the intensity of each pixel as stored in the static memory.

This allows sending a command to write intensities of pixels only when a change occurs in the scene which is represented, thereby further reducing the amount of data to transmit.

In a number of embodiments of the invention, said input interface is a Serial Peripheral Interface.

In a number of embodiments of the invention, said processing unit is configured to calculate a bit depth of the pixel intensity representation in the payload according to a target precision of said conversion.

By “target precision of the conversion”, we designate a precision of the bit depth which is targeted either for writing the intensities of the pixels.

This allows obtaining the lowest possible size of the payload that provides the target precision of the conversion.

In a number of embodiments of the invention, wherein said processing unit is configured, upon the displacement of an object from a first position to a second position in a 2D scene, to: send to the interface of said digital display a first command to write pixels of a first 2D shape that encompasses the object at the first position and represents the background of the 2D scene; send to the interface of said digital display a second command to write pixels of a second 2D shape that encompasses the object at the second position and represents the object.

This allows, when an object moves in a 2D scene from the first to the second position, to first redraw the background in the first position, then draw the object in the second position. Therefore, if the representation of the object in the first and second position overlap, the object will not appear in double.

Furthermore, this allows sending the minimal amount of data for representing the displacement of the object, provided that no other part of the 2D scene is impacted by the displacement.

### BRIEF DESCRIPTION OF DRAWINGS

Other features, details and advantages will be shown in the following detailed description and on the figures, on which:

FIG. 1 represents an example of a system in which the invention can be implemented, in a number of embodiments of the invention.

FIG. 2 represents an example of an architecture of a display system in a number of embodiments of the invention.

FIG. 3 represents an example of a method according to number of embodiments of the invention.

FIG. 4 represents an example of command to write a line of pixels with a bit depth of 8 bits, in a number of embodiments of the invention.

FIG. 5 represents an example of command to write a line of pixels with a bit depth of 4 bits, in a number of embodiments of the invention.

FIG. 6 represents an example of command to write a line of pixels with a bit depth of 1 bit, in a number of embodiments of the invention.

### DESCRIPTION OF EMBODIMENTS

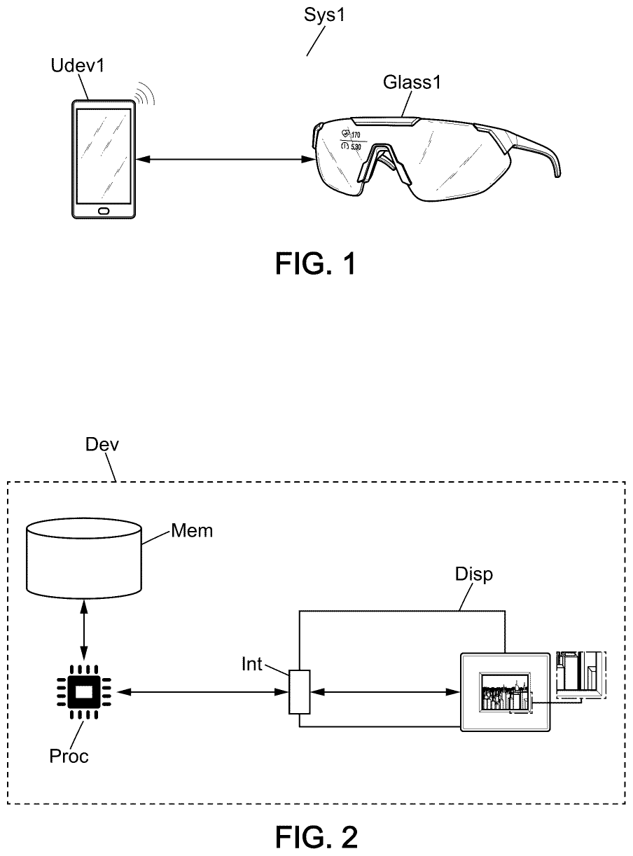

It is now referred to FIG. 1.

FIG. 1 represents an example of a system Sys1 in which the invention can be implemented.

The system Sys1 comprises a user device Udev1, and a pair of glasses Glas1.

In the example of FIG. 1, the user device which is represented is a smartphone. The invention is however not restricted to this example, and different user devices with connection capabilities, such as a smartwatch a tablet or the like may be used.

The user device Udev1 is connected to a pair of glass Glas1, for example by a short range radio connection, such as a Bluetooth connection.

The pair of glasses Glas1 may be a glass configured to display information in superposition to the view from the glasses, for example using a OLED display. For example, the applicant developed the Activelook® glasses which use a microoled display to represent information in superposition to the scene that the wearer views through the glasses. The Activelook glasses are equipped with lightweight memory and computing resources to process the display commands sent by the user device Udev1, so that the Activelook glasses are light, comfortable and perfectly fit for sports or other outdoor uses.

The user device Udev1 can thus send commands to the glasses Glas1 to display information in superposition to the scene which is viewed through the glasses. For example, if the user is running, the user device Udev1 can be equipped with sensors to measure information such as the running speed, heart rate of the user, duration of the run, etc. and send commands representing this information to the glasses Glas1, so that the user is able to see through the glasses his running speed, heart rate etc. while running. Meanwhile, the glasses Glas1 receives only display commands, and do not need to be equipped with powerful processors to process complex information such as the information provided by the sensors.

One of the objectives of the system Sys1 is to minimize the amount of data to be transferred from the device Udev1 to the pair of glasses Glas1, and processed by the pair of glasses Glas1. The invention can be used to this effect in order to reduce the size of the data frames that are transmitted by the user device Udev1 to the pair of glasses Glas1.

The system Sys1 is however provided by means of non-limitative example only of a system in which the invention can be implemented. The invention can indeed be implemented by other systems comprising an active matrix display. For example, other kind of near eye display devices than glasses may be used.

It is now referred to FIG. 2.

FIG. 2 represents an example of an architecture of a display device in a number of embodiments of the invention.

The display device Dev comprises:
an active matrix digital display Disp comprising:
   a plurality of pixels, each pixel comprising a static memory storing one or more values of intensity of the pixel;
   an interface Int;
a processing unit configured to send to the interface of said digital display at least one command.

The processing unit is therefore configured to send commands to the interface Int to write the memories of the pixels of the display Disp in order to cause a modification of the display in order to determine what is currently displayed. For example, writing values of intensities of pixels in the display of the connected pair of glasses Glas1 causes the display of the pixel in superposition to what the wearer sees through the glasses.

The interface may be a serial or parallel interface. For example, it may be a Serial Peripheral Interface. The interface is able to process the commands, write and read the intensities of pixels, receive pixel intensities to write, and send pixel intensities that have been read.

The display device may be of various type. For example, it may be a pair of glasses such as the glasses Glas1, or another kind of near-eye device.

The digital display Disp is configured to execute a method such as the method P3 described below.

As will be explained in more details below, this allows the processor Proc to send commands that modify the display screen.

As will be explained in more details below, the commands according to the invention allow defining a bit depth of the payload of the command, and the representation of the intensities of the pixels are converted between the bit depth of the pixel representation of the payload and the bit depth of the memories of the pixels of the display. A plurality of commands and/or parameters of the commands allow defining different bit depths of the payloads.

The processing unit Proc can therefore define, for each command, a bit depth of the payload which is best suited for the command. For example, the processing unit may be configured to calculate a bit depth of the pixel intensity representation in the payload according to a target precision of the conversion of the bit depth between the representation of the intensities pixels in the memories of the pixel and in the payload.

The target precision of the conversion may be used either in write mode, and may be obtained according to different needs. The target precision may for example be defined according to:
a bit depth required by an application that writes the values of intensities of the pixels. For example, if an application requires writing the intensities of pixels with a bit depth of 4 bits, the processing unit may set a bit depth of the payload of the command of 4 bits, even if the bit depth of the representation of the intensities of the pixels in the memories of the pixels is 8 bits;
the content of the pixels to write. For example, if the content to display is a pure graphical content, for example numbers, and that each pixel is either “ON” (i.e at the maximal intensity), or “OFF” (i.e at the minimal intensity), the processing unit may set a bit depth of the payload of the command of 1 bits, whatever the bit depth of the representation of the intensities of the pixels in the memories of the pixels. If a low number of colors or grayscale levels are required, a low number of bits, for example 2 or 4 bits, may be used.

It is therefore apparent that the processing unit can set, for each command, an optimal bit depth of the representation of the intensities of the pixel in the payload, in order that size of the payload is the lowest size that allows transferring the information between the processing unit Proc and the display Disp.

In a number of embodiments of the invention, some of these commands define subsets of the display screen to write or read, and comprise only the information to write the values of intensities of the pixel in the subsets of the screen. Commands to modify a subset of the display are especially useful when the pixels are equipped with static memories, because they limit the amount of data to transmit to the data relative to the subsets of the display that are modified.

According to various embodiments of the invention, the processing unit may perform complex operations to determine the commands to send, that is to say the type of command and the associated payload, or receive directly the command to send.

For example, if the display device Dev is the pair of glasses Glas1, the processing unit Proc may receive directly the commands to send from the user device Udev1, or receive higher level commands and perform calculations to determine the commands to send to the display Disp.

For example:
the processor may receive a command that specifies a bit depth, or determine the bit depth to use for the command;
the processor Proc may receive from the user device Udev1 commands to display a text in a corner of the display Disp. The text to display may for example be the time of the day, in a format “HH:MM” (the hour: minutes, for example “17:05” for 5 p.m and 5 minutes). The processor Proc may receive a new command each minute, when the display needs to be modified;
if the pixels have static memories, only the pixels whose intensity have changed may thus be modified. The processor Proc may thus be configured to send a command to the interface Int to modify only a subset of the display where pixels are modified. To this effect, the processor Proc may have access to a memory Mem wherein the current state of the display is stored in the form of a bitmap image, in order to be permanently aware of the state of each pixel of the display.

In another example, the processor Proc receives coordinates of an object to displace from an initial position to a final position, for example a mouse cursor.

The processing unit may thus be configured to:
send to the interface Int a first command to write pixels of a first 2D shape that encompasses the object at the initial position and represents the background of the 2D scene;
send to the interface Int a second command to write pixels of a second 2D shape that encompasses the object at the final position and represents the object.

Stated otherwise, in order to displace an object in a 2D scene, the processing unit can send a first command to redraw the background of the 2D scene at the initial position, then a second command to draw the object at the final position.

For each command, pixels are written only in a 2D shape that encompasses the object. Therefore, a minimal amount of data is sent to the interface.

These examples demonstrate how some of the embodiments of the invention can be used to modify dynamically the display while sending minimal amount of data to the interface. They are however provided by means of non-limitative examples of a use of the invention to modify the display of the display device Dev.

More generally, a processing unit which sends commands to the interface Int is able to use commands to write pixels only in 2D shapes wherein there are pixel intensities to write.

We will now describe in greater details how the commands are processed by the interface Int.

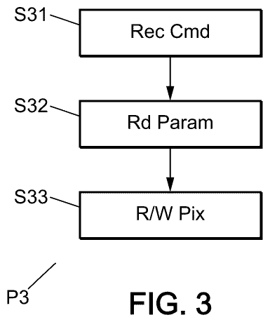

It is now referred to FIG. 3.

FIG. 3 represents an example of a method according to a number of embodiments of the invention.

The method P3 is a method executed by a display comprising a plurality of pixels, each pixel comprising a memory storing one or more values of intensity of the pixel, and an interface, such as for example the display Disp represented in FIG. 2.

The method P3 comprises a first step S31 of receiving, by the interface, at least one command to write pixel intensities in a region of the screen.

The command may be a command to write pixel intensities in a region of the screen.

The command may comprise:
an identifier of the command, which defines a command type, and the organization of the payload of the command (e.g the position of the parameters in the payload, the size of the command in certain cases, etc.);
the payload of the command.

The type of the command may belong to different types. For example, some commands may be used to write the whole screen. Some other commands may be used to write a 2D shape which forms a subset of the screen, or a line of the screen.

The method P3 further comprises a second step S32 of reading, from at least one of an identifier of a type of the command, and parameters of the command, a bit depth of the pixel intensity representation in the payload of the command.

Stated otherwise, the bit depth of the pixel intensity representation in the payload of the command is not necessarily the same than the bit depth of the pixel intensity representation in the memories of the pixels of the display, and the bit depth of the pixel intensity representation in the payload of the command is retrieved from the command type and/or parameters of the command, in order to be able to perform the conversion between the two representations.

The pixel intensity representation in the payload of the command may for example equal to, or lower than the bit depth of the pixel intensity representation in the memories of the pixels of the display. A pixel intensity representation in the payload of the command lower than the pixel intensity representation in the memories of the pixels allows reducing the size of the payload and thus the size of the commands to transmit.

For example, if the memories of the pixels store values of intensity in a 8-bits scale, the bit depth of the pixel intensity representation in the payload of the command may be any number between 1 and 8 bits. For example, the pixel intensity representation in the payload of the command may have a bit depth of 1, 2, 4 or 8 bits.

It is worth noting that the bit depth of the payload of the command can be adapted for each command. Therefore, the bit depth of the pixel representation of the payload can be adjusted to be the lowest bit depth which is sufficient to send transmit pixel intensities with a sufficient precision.

Therefore, the size of the command can be the lowest size that provides a sufficient amount of information to write the pixels.

The bit depth of the pixel intensity representation in the payload may be defined by the type of the command itself. For example, at least one type of command can be associated with a predefined bit depth, in order to further reduce the size of the command.

The bit depth of the command may also be defined by a parameter of the command. For example, a same type of command may be used with different bit depths. In this case, the type of command is associated with at least one bit depth parameter. This provides more flexible commands, that can be associated with a plurality of different bit depths of the payloads.

The method P3 further comprises a step S33 of writing to the memory from the payload of the command values of intensities of pixels of the region of the screen according to said at least one parameter and a pixel path associated to said region of the screen.

Stated otherwise, the intensities of the pixel are read from the memories of the pixels to the payload, or written from the payload to the memories of the pixels the payload in a defined pixel path. The pixel path may for example consist in reading or writing the region line by line, for example from left to right and top to bottom. Of course, many other different pixel paths may be considered. For example, the pixel path may be a column by column pixel path, the pixels may be read from left to right or from right to left, from top to bottom or from bottom to top, etc.

The number of values of intensity to write depends upon the number of channels of the color representation of the pixel.

For example:
If the color representation of the pixels is a grayscale representation, a single value of intensity, representing the luminosity of the pixel, can be written;
If the color representation of the pixels comprises a plurality of channels, a plurality of values of intensity can be written, corresponding respectively to a plurality of sub-pixels corresponding to each of the color channels. For example, a RGB representation corresponds to 3 values of intensities of Red, Green and Blue sub-pixels respectively, a RG representation corresponds to 2 values of intensities of Red and Green sub-pixels respectively, a RGBW representation corresponds to 4 values of intensities of Red, Green, Blue and White sub-pixels respectively. Any color representation comprising a plurality of channels can be used in according to various embodiments of the invention.

Said step S33 of writing comprises a conversion between the bit depth of the pixel intensity representation in the payload, and the bit depth of the pixel intensity representation in the memory, if the bit depth of the pixel intensity representation in the payload and the bit depth of the pixel intensity representation in the memory are different.

Stated otherwise, when the bit depth of the pixel intensity representation are different between the payload and the memories of the pixels, a conversion is performed by the interface. For example, if the bit depth of the representation of the memories of the pixels is 8 bits, and the bit depth of the representation of the payload is 4 bits, the intensities of pixels will be converted from 8 to 4 bits from the representation in the payload to the representation in the memories of the pixels.

It is worth noting that this example is provided for pixels represented using a single color channel, for example grayscale pixels. For pixels represented using a plurality of color channels, for example RGB pixels represented using 3 color channels R, G and B, the conversion can be performed for each color channel. For example, if the representation of the intensities of pixels in the memories of the pixels is a 24-bits RGB representation (8 bits per color channel for each pixel), and the representation of the intensities of pixels in the payload is a 12-bits RGB representation (4 bits per color channel for each pixel), the conversion between 8 and 4 bits can be performed for each of the three R, G and B channels separately.

It is thus apparent that the invention allows reducing the payload size required to write pixels of a given region of the screen.

For example, if the bit depth of the pixel representation of the payload is 1, while the bit depth of the pixel representation of the pixel representation of the memories of the pixels is 8, the invention allows a reduction of the size of the representation of the pixels in the payload by a factor 8. If the intensities of the pixels to write corresponds to pixel in a “ON” or “OFF” state, this does not cause any loss of information. In other cases, this may cause a negligible or acceptable loss of information, while allowing a substantial reduction of the size of data to transmit. As previously stated, the bit depth of the payload can be tailored for each specific command.

The invention therefore allows a significant reduction of the latency and energy consumption of the processing of the commands by the interface.

For example, a pixel intensity of a pixel (or a pixel channel) can be represented by a single bit, which may have a first possible binary value (for example 1) representative of a maximum intensity, or a second possible binary value (for example 2) representative of a minimum intensity.

During the conversion, the interface can write in the memory of the pixel a value representative of a maximum or a minimum intensity accordingly.

For example:
If the pixel intensity representation of the pixel in the payload is a first possible binary value, for example 1, and the representation of pixel intensity in the memory of the pixel is a 8-bits unsigned representation, the interface may be configure to write a value “255” in the memory of the pixel;
If the pixel intensity representation of the pixel in the payload is a second possible binary value, for example 0, and the representation of pixel intensity in the memory of the pixel is a 8-bits unsigned representation, the interface may be configure to write a value “0” in the memory of the pixel.

In order to obtain the most compact possible representation of the pixel intensities, the pixel intensity representations in the payload are concatenated for each successive pixel in the region according to the pixel path.

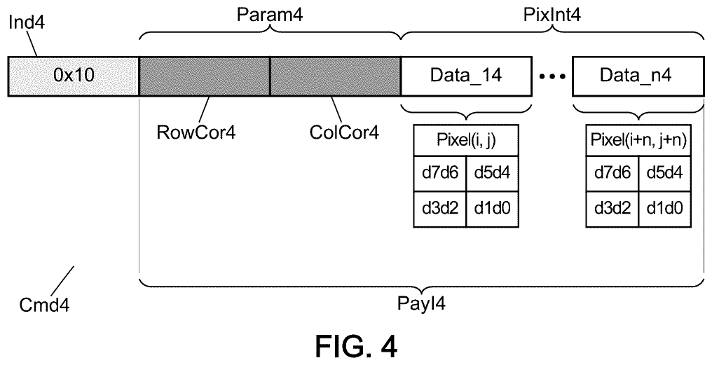

We will now provide examples of such commands, with reference to the FIGS. 4, 5 and 6.

In the examples of FIGS. 4 to 6, the position of each pixel is defined by a row index, and a column index, and the position of the pixel is noted as (column index, row index). Each of the commands aims at writing a line starting from a pixel of position (i,j). In the convention of the FIGS. 4 to 6, the origin of the coordinate system of the pixels (and thus the pixel of coordinates (1,1)) is the top-left corner of the screen, and the pixel path for each command is a column-by-column pixel path, from top to bottom, and left to right and. This coordinate system and pixel path are however provided by means of non limitative example only, and the invention is applicable to other coordinate systems and pixel paths.

In the example of FIGS. 4 to 6, the pixels are grayscale pixels, which means that each pixel is defined by a single value of intensity. Of course, the examples of FIGS. 4 to 6 may be extended to other color spaces. For example, if pixels are RGB pixels having 3 color components R, G and B, each pixel is associated to 3 values of pixel intensity instead of one.

In the FIGS. 4 to 6, the contents of the bytes of the payload that represent intensities of pixels will be represented by 8 bits d0, d1, d2, d3, d4, d5, d6, d7 and d8 for each byte. Even if the notations d0, d1, d2, d3, d4, d5, d6, d7 and d8 are repeated over the FIGS. 4 to 6, each bit will be linked in the figure to a byte, and is therefore clearly defined. For example, the bit d0 of the byte Data_14 in FIG. 4 represents the content of the bit of index 0 in the byte Data_14 of the payload Payl4.

It is now referred to FIG. 4.

FIG. 4 represents an example of command to write a series of columns of pixels with a bit depth of 8 bits, in a number of embodiments of the invention.

The command Cmd4 is a command to write a series of columns in the display screen, starting from a pixel of coordinates (i,j), wherein i is an index of the column of the pixel and j an index of the line of the pixel. The command comprises:
an identifier of command Id4 (in this example the command is 0x10). In this example, the command 0x10 is a command to draw columns using a 8-bits representation of the intensities of pixels in payload;
a payload Payl4 comprising:
   parameters Param4 comprising:
      pixel coordinates of a first pixel of the column to write, defined by its row index RowCor14 and column index ColCor14;
   pixel intensities PixInt4, comprising n bytes of data Data_14 to Data_n4.

As the bit depth of the pixel representations in the payload is 8 bits, each byte Data_14 to Data_n4 stores the value of intensity of a single pixel. The pixel path is defined a column-by-column traversal of the screen: pixels are written from the pixel (i,j) by traversing the screen to the bottom of the column j, then, once the bottom of the column j is reached, goes to pixel (i; j+1) and crosses the column j+1 in direction of the bottom. The columns of pixels are thus iteratively written until all the values of pixel intensities in the payload has been processed.

For example:
the byte Data_14 comprises the value of intensity of the pixel of coordinates (i,j), which is therefore defined by the eight bits d0 to d7 of byte Data_14;
the last byte Data_n4 of the payload comprises the value of intensity of the pixel of coordinates (i+n,j+n), which is therefore defined by the eight bits d0 to d7 of byte Data_n4.

Therefore, the representation of the pixels in the bit depth defined by the command (in this example, a 8-bits bit depth) are concatenated in the payload, in an order defined by the pixel path. The n bytes PixInt4 representing pixel intensities in the payload store values of pixel intensities of n pixels.

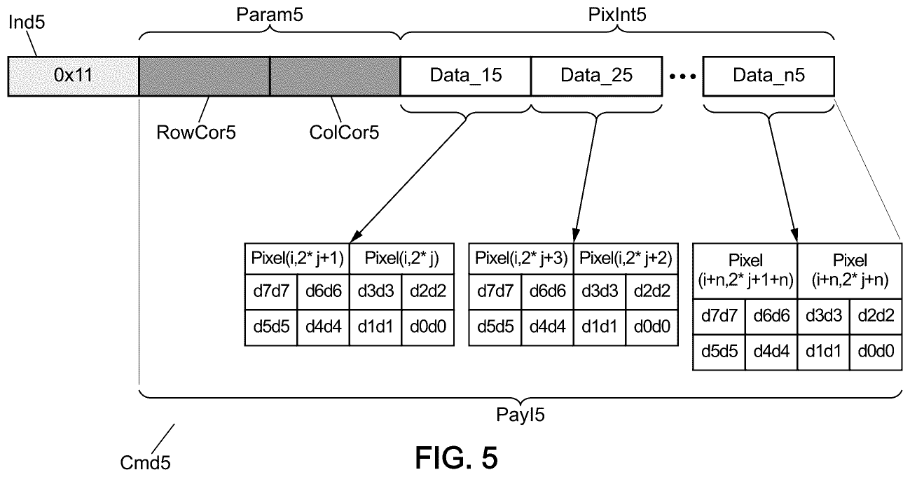

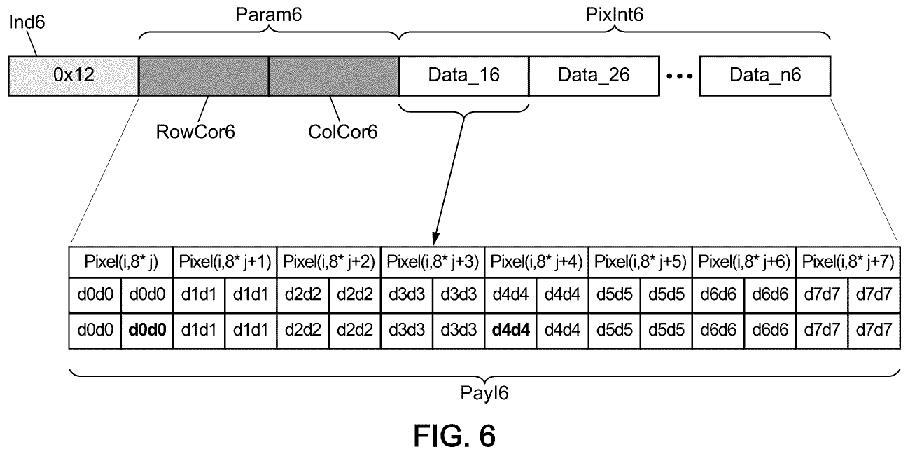

While FIG. 4 represented an example wherein the bit depth of the pixel intensity representation in the payload and the bit depth of the pixel intensity representation in the memory are the same (8 bits each), and thus wherein no conversion occurs, FIGS. 5 and 6 represent examples of commands wherein the pixel intensity representation in the payload is lower than the bit depth of the pixel intensity representation in the memory. In such example, a conversion is performed to convert the values of intensities between the two representations.

More specifically, the examples of FIGS. 5 and 6 represent two examples wherein the bit depth of the pixel intensity representation in the payload of the command is equal to the bit depth of the pixel intensity representation in the memory of the pixels divided to a power of 2 (which is for example the case if a 8-bits representation in the memories of the pixel, and 4, 2 or 1 bit depth representation in the payload).

In a number of embodiments of the invention, when the bit depth of the pixel intensity representation in the payload of the command is equal to the bit depth of the pixel intensity representation in the memory of the pixels divided to a power of 2, the conversion can be performed by duplicating the bits from the payload of the command to the memories of the pixel to write the values of intensities of pixels.

The duplication of the bits from the payload consists in setting the value of a bit from the payload a plurality of times in the pixel memory. For example, in the examples of FIGS. 5 and 6, the pixels are organized by sub-pixels of 2 bits, and the bits of the payload are duplicated as series of 2, 4, etc. identical bits. This example is however provided by means of example only, and other conversions are foreseeable. For example, the bits of the payload that are associated to a pixel intensity may define the Most Significant Bits of the pixel.

The selection of the bits consists in selecting the most relevant bits from the memory (usually the most significant bits) to copy from the memory of a pixel to the corresponding area of the payload.

It is now referred to FIG. 5.

FIG. 5 represents an example of command to write a series of columns of pixels with a bit depth of 4 bits, in a number of embodiments of the invention. The pixel path is the same as discussed in the FIG. 4, but the number of pixels that can be written from the same number of bytes of the payload is multiplied by two.

The command Cmd5 is a command to write a column in the display screen, starting from a pixel of coordinates (i,j). The command comprises:
an identifier of command Id5 (in this example the command is 0x11). In this example, the command 0x11 is a command to draw a series of columns using a 4-bits representation of the intensities of pixels in the payload;
a payload Payl5 comprising:
   parameters Param5 comprising:
      pixel coordinates of a first pixel of the line to write, defined by its row index RowCor15 and column index ColCor15;
   pixel intensities PixInt5, comprising n bytes of data Data_15 to Data_n5.

As the bit depth of the pixel representations in the payload is 4 bits, each byte Data_15, Data_25 . . . Data_n5 stores the values of intensity of two pixels.

For example:
the byte Data_15 comprises:
   the value of intensity of the pixel of coordinates (i,2*j), which is defined by the first four bits d0 to d3 of byte Data_15. In this example, the conversion is performed in the following manner: the four bits d0, d1, d2 and d3 are duplicated from the payload to the memory as series of successive bits, to obtain the following bit representation of the pixel d3 d3 d2 d2 d1 d1 d0 d0. The same conversion will be performed for the subsequent pixels:
   the value of intensity of the pixel of coordinates (i,2*j+1), which is defined by the last four bits d4 to d7 of byte Data_15;
the byte Data_25 comprises:
   the value of intensity of the pixel of coordinates (i,2*j+2), which is defined by the first four bits d0 to d3 of byte Data_25;
   the value of intensity of the pixel of coordinates (i,2*j+3), which is defined by the last four bits d4 to d7 of byte Data_25;
. . .
the byte Data_n5 comprises:
   the value of intensity of the pixel of coordinates (i+n,2*j+n), which is defined by the first four bits d0 to d3 of byte Data_n5;
   the value of intensity of the pixel of coordinates (i+n,2*j+1+n), which is defined by the last four bits d4 to d7 of byte Data_n5;

Therefore, the representation of the pixels in the bit depth defined by the command (in this example, a 4-bits bit depth) are concatenated in the payload, in an order defined by the pixel path. The n bytes PixInt5 representing pixel intensities in the payload store values of pixel intensities of n*2 pixels.

It is worth noting that the example of conversion provided in FIG. 5 is provided by means of non-limitative example only. For example, in other embodiments of the invention, the bit representation of the pixel of coordinates (i, 2*j) may be d3 d2 d1 d0 d3 d2 d1 d0 , or d3 d2 d1 d0 d0 d0 d0 d0 instead of d3 d3 d2 d2 d1 d1 d0 d0. Stated otherwise, the bits may define the most significant bits instead of being duplicated as series of successive identical bits.

It is now referred to FIG. 6.

FIG. 6 represents an example of command to write series of columns of pixels with a bit depth of 1 bit, in a number of embodiments of the invention.

The command Cmd6 is a command to write a series of columns of pixels in the display screen, starting from a pixel of coordinates (i, j). The command comprises:
an identifier of command Id6 (in this example the command is 0x12). In this example, the command 0x12 is a command to draw a series of columns using a 1-bit representation of the intensities of pixels in payload;
a payload Payl6 comprising:
   parameters Param6 comprising:
      pixel coordinates of a first pixel of the line to write, defined by its row index RowCor16 and column index ColCor16;
   pixel intensities PixInt6, comprising n bytes of data Data_16 to Data_n6.

As the bit depth of the pixel representations in the payload is 1 bit, each byte Data_16, Data_26 . . . Data_n6 stores the value of intensity of a two pixels.

For example:
the byte Data_16 comprises:
   the value of intensity of the pixel of coordinates (i,8*j), which is defined by the first bit d0 of byte Data_16; In this example, the conversion is performed by duplicating 8 times the value of the bit d0 of Data_16 to the memory of the pixel of coordinates (i, 8*j). For example, if d0 is 0, the conversion will write the binary value 00000000 (or the hexadecimal value 0x00) in the memory of the pixel of coordinates (i, 8*j); if d0 is 1, the conversion will write the binary value 11111111 (or the hexadecimal value 0xFF in the memory of the pixel of coordinates (i, 8*j);
   the value of intensity of the pixel of coordinates (i,8*j+1), which is defined by the second bit d1 of byte Data_16; In this example, the conversion is performed by duplicating 8 times the value of the bit d1 of Data_16 to the memory of the pixel of coordinates (i, 8*j+1);
   the value of intensity of the pixel of coordinates (i,8*j+2), which is defined by the second bit d2 of byte Data_16; In this example, the conversion is performed by duplicating 8 times the value of the bit d2 of Data_16 to the memory of the pixel of coordinates (i, 8*j+2);
   the value of intensity of the pixel of coordinates (i,8*j+3), which is defined by the second bit d3 of byte Data_16; In this example, the conversion is performed by duplicating 8 times the value of the bit d3 of Data_16 to the memory of the pixel of coordinates (i, 8*j+3);
   the value of intensity of the pixel of coordinates (i,8*j+4), which is defined by the second bit d4 of byte Data_16; In this example, the conversion is performed by duplicating 8 times the value of the bit d4 of Data_16 to the memory of the pixel of coordinates (i, 8*j+4);
   the value of intensity of the pixel of coordinates (i,8*j+5), which is defined by the second bit d5 of byte Data_16; In this example, the conversion is performed by duplicating 8 times the value of the bit d5 of Data_16 to the memory of the pixel of coordinates (i, 8*j+5);
   the value of intensity of the pixel of coordinates (i,8*j+6), which is defined by the second bit d6 of byte Data_16; In this example, the conversion is performed by duplicating 8 times the value of the bit d6 of Data_16 to the memory of the pixel of coordinates (i, 8*j+6);
   the value of intensity of the pixel of coordinates (i,8*j+7), which is defined by the second bit d1 of byte Data_17; In this example, the conversion is performed by duplicating 8 times the value of the bit d1 of Data_17 to the memory of the pixel of coordinates (i, 8*j+7).
Etc.

Therefore, the representation of the pixels in the bit depth defined by the command (in this example, a 1-bits bit depth) is concatenated in the payload, in an order defined by the pixel path. The n bytes PixInt6 representing pixel intensities in the payload store values of pixel intensities of n*8 pixels.

These examples demonstrate that the invention allows a substantial reduction of the amount of data necessary to transmit the intensities of a same number of pixels, or conversely allows writing a much higher number of pixels with commands of the same size. For example, using n bytes of data:
n pixels are written using command Cmd4 with a 8-bits definition;
n*2 pixels are written using command Cmd5 with a 4-bits definition;
n*8 pixels are written using command Cmd6 with 8-bits definition.

The commands Cmd4 to Cmd6 are provided by means of non-limitative examples of commands in a number of embodiments of the invention. Other commands may be defined. For example, they may be commands to write other shapes than lines. For example, some commands may write the entire screen 2D shapes such as rectangle, triangles, squares, circles, etc

The examples of FIGS. 4, 5 and 6 represent examples of commands to draw series of columns.

The invention is however not restricted to these examples, and may be applied to commands to write the entire screen, or 2D shapes.

Commands to write 2D shapes are especially useful in order to write only a specific part of the screen, for example a part of the screen where a change occurred. The intensities of pixels can therefore retrieved in the payload according to a pixel path to write the pixels in the 2D shape that represents a subset of the screen, and the bit depth of the payload.

To this effect a second step S32 may further comprise reading, in a predefined position of a payload of the command, at least one parameter relative to at least a pixel position in the display screen.

Stated otherwise, in embodiments wherein a command is a command to write a 2D shape, the type of command allows retrieving predefined types and positions of at least one parameter of the command, and the step S32 consists in reading, at the predefined positions, at least one parameter of the command. The positions of the pixel may be expressed as a row and a column index in the screen for example.

The at least one parameter of the command comprises at least a pixel position in the display screen and may also comprise other parameters relative for example to the size, shape or orientation of the 2D shape.

The size and shape of the 2D shape are therefore known, at the output of step S32, either from the at least one parameter, the command type, or a combination thereof.

For example:
the command type may define a precise shape, for example an object whose size is known. The use of a parameter relative to a defined pixel of the shape (for example, the pixel at the extremity of a mouse cursor), is therefore sufficient to determine precisely all the pixels in the screen that belong to the shape;
the command type may define a shape type, for example a rectangle, and the at least one parameter may define the rectangle size, for example its height and width. In combination with the position of at least one pixel, this also allows determining precisely all the pixels in the screen that belong to the shape.

Therefore, in embodiments wherein a command is a command to write a 2D shape that represents a subset of the screen, at the end of step S32, the size and position of the 2D shape are known.

In embodiments wherein a command is a command to write a 2D shape that represents a subset of the screen, the third step S33 comprises writing to the memories of the subset of pixels of the screen values of intensities of said subset of pixels based at least on said at least one parameter. The conversion is applied to the values of intensities of each pixel of the 2D shape.

Stated otherwise, the intensities of the pixels are written only for the pixels in the 2D shape which is defined by the identifier of the command and the at least one parameter. Thus, the amount of data that is transferred is reduced. This therefore allows further reducing the time to write the pixels and saving energy in the process of writing the intensities of pixels.

In general, writing pixels is based on reading the payload, and writing the intensities of the pixels in the memories of the pixels accordingly.

Writing the pixel intensities may be performed in different ways.

In embodiments wherein a command is a command to write a 2D shape that represents a subset of the screen, the payload of the command comprises the values of intensities of said subset of pixel, and said interface is configured to write said values of intensities according to a pixel path associated to said 2D shape.

Stated otherwise, the payload of the command thus comprises the intensities of pixels themselves, in a predefined order corresponding to a pixel path in the 2D shape, and the intensities of pixels are written in the payload in the order defined by the pixel path, after having been converted.

For example, the type of the command may define a 2D shape associated with a predefined pixel path.

In a number of embodiments of the invention, a type of command may correspond to a defined 2D shape defined pixel by pixel with a known predefined pixel path.

This is useful for representing specific 2D shapes. For example, a specific command may be defined to write a mouse pointer of a defined size. The payload then only needs to comprise the intensities of each of the pixel of the mouse cursor in a defined order.

In other embodiments of the invention:
The payload further comprises at least one parameter relative to at least one dimension of the 2D shape;
the size of the payload of the command is dependent upon said at least one dimension;
the pixel path is parameter according to said at least one dimension.

Such embodiments are relative to the writing of shapes of variable sizes. For example, the 2D shape may be a rectangle that may have different sizes, a mouse cursor that may have different sizes, etc.

As noted above, the at least one parameter relative to at least one dimension may be any kind of parameter that allows inferring the dimension (the dimension itself, a surface of the shape, a second pixel position, etc.).

For example, if the 2D shape is a rectangle, at least one parameter relative to at least a pixel position represents a first pixel position of a first corner of the rectangle, and the at least one parameter relative to at least one dimension may comprise:
a pixel position of a corner of the rectangle opposite to the first corner;
a height and width of the rectangle.

Thus, in both cases, the size and position of the rectangle can be inferred from the first pixel position representing a first corner, and the parameters relative to at least one dimension.

Thus, the at least one dimension allows determining the pixels that belong to the 2D shape, and the pixel path can be parameter accordingly. For example, the pixel path may comprise pixel intensities of pixels line by line, in a predefined direction (for example left to right and top to bottom).

The commands may also define other shapes defined by position and size parameters.

For example:
one command may define a discus, by the position of a predefined point (for example a center of the discus, a top, bottom, extreme left or extreme point of the discus, a corner of a square that encompasses the square, or more generally any point that can be located with respect to the discus), and a size of the discus (for example a radius, a diameter, a surface or a perimeter of the discus);
One command may define a triangle, with parameters that define the positions of the 3 corners of the triangle;
Etc.

Each of these commands allows defining deterministically the pixels that belong or not to a shape. Once the pixel that belong to a shape are known, a predefined pixel path can be applied, for example a line-by-line traversal or a column-by-column traversal of the pixels that belongs to the shape to write the shape.

This disclosure is not limited to the digital display, device, method, computer software and computer-readable non-transient recording medium described here, which are only examples. The invention encompasses every alternative that a person skilled in the art would envisage when reading this text.

1. An active matrix digital display comprising:
a plurality of pixels, each pixel comprising a static memory adapted to store a plurality of n bits representing the intensity of the pixel;
an interface configured, upon the reception of at least one command to write pixel intensities in a region of the screen, to:
determine, from at least one of an identifier of a type of the command, and parameters of the command, a bit depth of the pixel intensity representation in the payload of the command;
write to the memory from the payload of the command values of intensities of pixels of the region of the screen according to said bit depth of the pixel intensity representation in the payload and a pixel path associated to said region of the screen;
wherein said write comprises a conversion between the bit depth of the pixel intensity representation in the payload, and the bit depth of the pixel intensity representation in the memory, if the bit depth of the pixel intensity representation in the payload and the bit depth of the pixel intensity representation in the memory are different and
wherein the pixel intensity representations in the payload are concatenated for each successive pixel in the region according to the pixel path.

2. The digital display of claim 1, wherein at least one type of command is associated with a predefined bit depth.

3. The digital display of claim 1, wherein:
the bit depth of the pixel intensity representation in the payload is equal to 1;
said conversion comprises, for each pixel:
if the pixel intensity representation of the pixel in the payload is a first possible binary value, write a maximum intensity of the pixel in the memory;
if the pixel intensity representation of the pixel in the payload is a second possible binary value different from the first possible binary value, write a minimum intensity of the pixel in the memory.

4. The digital display of claim 1 wherein, if the pixel intensity representation in the payload of the command is equal to the bit depth of the pixel intensity representation in the memory of the pixels divided to a power of 2 and, the conversion is performed by duplicating the bits from the payload to the memory to write to the memory from the payload of the command values of intensities of pixels.

5. The digital display of claim 1 wherein, if the type of the command of the command belongs to at least one type relative to a subset of the screen, said interface is further configured to read, in a predefined position of a payload of the command, at least one parameter relative to at least a pixel position in the screen.

6. The digital display of claim 5, wherein, if the type of the command of the command belongs to at least one type relative to a 2D shape:
said at least one parameter further comprises at least one parameter relative to at least one dimension of the 2D shape;
the size of the payload of the command is dependent upon said at least one size;
the pixel path is parameter according to said at least one dimension.

7. The digital display of claim 1, wherein said input interface is a Serial Peripheral Interface.

8. The display device comprising:
the digital display of claim 1;
a processing unit configured to send to the interface of said digital display at least one command.

9. The display device of claim 8, wherein said processing unit is configured to calculate a bit depth of the pixel intensity representation in the payload according to a target precision of said conversion.

10. The display device of claim 8, wherein said processing unit is configured, upon the displacement of an object from a first position to a second position in a 2D scene, to:
send to the interface of said digital display a first command to write pixels of a first 2D shape that encompasses the object at the first position and represents the background of the 2D scene;
send to the interface of said digital display a second command to write pixels of a second 2D shape that encompasses the object at the second position and represents the object.

11. A method executed by an active matrix digital display comprising:
a plurality of pixels, each pixel comprising a static memory adapted to store a plurality of n bits representing the intensity of the pixel;
an interface
said method comprising:
receiving, by the interface, at least one command to write pixel intensities in a region of the screen;
determining, from at least one of an identifier of a type of the command and parameters of the command, a bit depth of the pixel intensity representation in the payload of the command;
writing to the memory from the payload of the command values of intensities of pixels of the region of the screen according to said at least one parameter and a pixel path associated to said region of the screen;
wherein said writing comprises a conversion between the bit depth of the pixel intensity representation in the payload, and the bit depth of the pixel intensity representation in the memory, if the bit depth of the pixel intensity representation in the payload and the bit depth of the pixel intensity representation in the memory are different and
wherein the pixel intensity representations in the payload are concatenated for each successive pixel in the region according to the pixel path.

12. The Computer software or system firmware comprising instructions to implement at least a part of a method according to claim 11 when the software is executed by a processor.

13. The Computer-readable non-transient recording medium on which a software is registered to implement a method according to claim 11 when the software is executed by a processor.
